(19) United States
(12) Patent Application Publication
(10) Pub. No.: US 2022/0383200 A1
(43) Pub. Date: Dec. 1, 2022

(54) METHOD AND APPARATUS FOR CONSTRUCTING MULTI-TASK LEARNING MODEL, ELECTRONIC DEVICE, AND STORAGE MEDIUM

(71) Applicant: Tencent Technology (Shenzhen) Company Limited, Shenzhen (CN)

(72) Inventors: Xiaokai Chen, Shenzhen (CN); Xiaoguang Gu, Shenzhen (CN); Libo Fu, Shenzhen (CN)

(21) Appl. No.: 17/883,439

(22) Filed: Aug. 8, 2022

Related U.S. Application Data
(63) Continuation of application No. PCT/CN2021/095977, filed on May 26, 2021.

(30) Foreign Application Priority Data
Jun. 17, 2020 (CN) 202010555648.0

(51) Int. Cl. G06N 20/00

(52) U.S. Cl. CPC G06N 20/00

(57) ABSTRACT

This application relates to a method for constructing a multi-task learning model, an electronic device, and a computer-readable storage medium. The method includes: constructing a search space formed between an input node and a plurality of task nodes by arranging a plurality of subnetwork layers and a plurality of search layers in a staggered manner. A search layer in the plurality of search layers is arranged between two subnetwork layers of the plurality of subnetwork layers. The method includes sampling a path from the input node to each task node of the plurality of task nodes through the search space to obtain a candidate path as a candidate network structure; and training a parameter of the candidate network structure according to sample data, to generate the multi-task learning model for performing a multi-task prediction.

### CROSS-REFERENCE TO RELATED APPLICATIONS

This application is a continuation application of PCT Patent Application No. PCT/CN2021/095977, entitled “METHODS, DEVICES, ELECTRONIC DEVICES AND STORAGE MEDIA FOR BUILDING MULTI-TASK LEARNING MODELS” filed on May 26 2021, which claims priority to Chinese Patent Application No. 202010555648.0, filed with the State Intellectual Property Office of the People's Republic of China on Jun. 17, 2020, and entitled “METHOD AND DEVICE FOR CONSTRUCTING MULTI-TASK LEARNING MODEL, ELECTRONIC EQUIPMENT AND STORAGE MEDIUM”, all of which are incorporated herein by reference in their entirety.

### FIELD OF THE TECHNOLOGY

This application relates to artificial intelligence technologies, and in particular, to a method and an apparatus for constructing multi-task learning model, an electronic device, and a computer-readable storage medium.

### BACKGROUND OF THE DISCLOSURE

Artificial intelligence (AI) is a comprehensive technology of computer science and is to study design principles and implementation methods of various intelligent machines, to enable the machines to have functions of perception, reasoning, and decision-making. The AI technology is a comprehensive subject, relating to a wide range of fields, for example, several major directions of natural language processing technology and machine learning/deep learning. With the development of technologies, the AI technology will be applied in more fields and play an increasingly important role.

In the related art, there is lack of an effective solution of determining a multi-task learning model based on AI, and it mainly relies on manual verification of various models to select the most suitable network structure as the multi-task learning model. However, this method is too inefficient and wastes a lot of manpower and material resources.

### SUMMARY

Embodiments of this application provide a method and an apparatus for constructing a multi-task learning model, an electronic device, and a storage medium, which can automatically and accurately construct a multi-task learning model, to improve the efficiency of constructing the multi-task learning model.

The technical solutions in the embodiments of this application are implemented as follows.

An embodiment of this application provides a method for constructing a multi-task learning model, including:

constructing a search space between an input node and a plurality of task nodes by arranging a plurality of subnetwork layers and a plurality of search layers in a staggered manner, wherein a search layer in the plurality of search layers is arranged between two subnetwork layers of the plurality of subnetwork layers;

sampling a path from the input node to each task node of the plurality of task nodes through the search space to obtain a candidate path as a candidate network structure; and

training a parameter of the candidate network structure according to sample data to generate the multi-task learning model for performing a multi-task prediction.

An embodiment of this application provides an apparatus for constructing a multi-task learning model, including:

a construction module, configured to construct a search space formed by a plurality of subnetwork layers and a plurality of search layers between an input node and a plurality of task nodes by arranging the subnetwork layers and the search layers in a staggered manner;

a sampling module, configured to sample a path from the input node to each task node through the search space, to obtain a candidate path as a candidate network structure; and

a generating module, configured to train a parameter of the candidate network structure according to sample data, to generate a multi-task learning model for performing multi-task prediction.

An embodiment of this application provides an electronic device for constructing a multi-task learning model, including:

a memory, configured to store executable instructions; and

a processor, configured to perform the method for constructing a multi-task learning model according to the embodiments of this application when executing the executable instructions stored in the memory.

An embodiment of this application provides a computer-readable storage medium, storing executable instructions, configured to perform the method for constructing a multi-task learning model according to the embodiments of this application during execution of a processor being caused.

The embodiments of this application have the following beneficial effects:

A search space of a multi-layer structure is constructed between an input node and a plurality of task nodes by arranging subnetwork layers and search layers in a staggered manner, and the search space is searched for a multi-task learning model for multi-task prediction according to sample data, to automatically and accurately construct the multi-task learning model, thereby improving the efficiency of constructing the multi-task learning model. Further, a multi-task learning model of a multi-layer structure is determined according to a search space formed by a plurality of subnetwork layers and a plurality of search layers, so that the multi-task learning model can perform hierarchical multi-task learning, to improve a learning capability.

### BRIEF DESCRIPTION OF THE DRAWINGS

FIG. 1 is a schematic structural diagram of a multi-gate mixture-of-experts model provided in the related art.

FIG. 2 is a schematic diagram of an application scenario of a system for constructing a multi-task learning model according to an embodiment of this application.

FIG. 3 is a schematic structural diagram of an electronic device for constructing a multi-task learning model according to an embodiment of this application.

FIG. 4 to FIG. 7 are schematic flowcharts of a method for constructing a multi-task learning model according to an embodiment of this application.

FIG. 8 is a schematic diagram of a search block according to an embodiment of this application.

FIG. 9 is a schematic diagram of a search space according to an embodiment of this application.

FIG. 10 is a schematic flowchart of a search process according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, the included term “first/second” is merely intended to distinguish similar objects but does not necessarily indicate a specific order of an object. It may be understood that “first/second” is interchangeable in terms of a specific order or sequence if permitted, so that the embodiments of this application described herein can be implemented in a sequence in addition to the sequence shown or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, a description is made on terms in the embodiments of this application, and the terms in the embodiments of this application are applicable to the following explanations.

(1) Deep learning (DL) is a new research direction in the field of machine learning (ML), is to learn an inherent law and a representation level of sample data, to obtain an interpretation of data such as text, images, and sounds, and finally enable a machine to have an analysis learning capability like people, recognize the data such as the text, the images, and the sounds, and imitate human activities such as audio-visual and thinking.

(2) Multi-task learning model is configured to perform multi-task classification or prediction. For example, for news recommendation, a click-through rate and a degree of completion of news are predicted by using a multi-task learning model, so that personalized news recommendation is performed according to the click-through rate and the degree of completion of the news.

The multi-task learning model includes an input node, a subnetwork layer, a search layer, and a task node. The input node corresponds to an entry of the multi-task learning model, and data received by the input node is used as the basis for a plurality of task nodes (that is, at least two task nodes) to perform a classification or prediction task. The subnetwork layer includes a plurality of subnetwork modules (that is, experts in a multi-gate mixture-of-experts model, and each subnetwork module is an independent neural network module and may be formed by a single fully connected layer and an activation function). The search layer includes a plurality of search blocks. Each search block represents a sub-search space and includes a plurality of local network structures (for example, connections between the subnetwork modules). The task node corresponds to an exit of the multi-task learning model, and a quantity of task nodes is related to a quantity of classification or prediction tasks that need to be implemented in a specific application scenario.

(3) Network parameter refers to a parameter of each module (for example, the subnetwork module, the search block, or the task node) in the network structure when performing calculation.

(4) Structural parameter is used for representing possibilities that local structures of a search block in a search space are sampled. For example, if an i^{th} search block includes N local structures, a structural parameter αᵢ is an N-dimensional vector, and a larger value of the structural parameter αᵢ indicates a larger possibility that a local structure corresponding to the value is sampled.

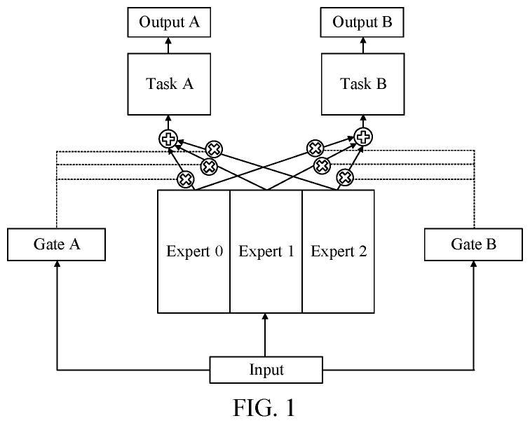

In the related art, multi-task learning is performed by using a multi-gate mixture-of-experts method. Compared with bottom sharing, by using the multi-gate mixture-of-experts method, each task can dynamically aggregate and share outputs of experts, and a multi-task direct relationship can be better processed. By using the multi-gate mixture-of-experts method, a bottom sharing layer is split into a plurality of experts (which are independent neural network modules and each expert may be formed by a single fully connected layer and an activation function), then outputs of the experts are dynamically aggregated by using gates, and a dynamically aggregated result is outputted to a corresponding task node. A quantity of experts is not limited in the multi-gate mixture-of-experts method, but gates and tasks are in one-to-one correspondence. Therefore, a quantity of gates is equal to a quantity of tasks. As shown in FIG. 1, a multi-gate mixture-of-experts model includes two task nodes, two gates, and three experts. It is assumed that an input is x, an input of the three experts is a d-dimensional vector x, and an output of the three experts is {eᵢ(x)}ᵢ₌₁³, e representing function transformation, that is, may be considered as a fully connected layer and a convolutional layer. For a task A, a gate A is configured to calculate weights (scalars) {sᵢ(x)}ᵢ₌₁³ of the three experts for the task A. The gate may be a fully connected layer, an input is a vector x, and an output is scores {aᵢ(x)}ᵢ₌₁³ of the three experts. The weights are obtained by transforming the scores by using a normalized exponential function, that is,

$${s}_{i} = \frac{exp ( {a}_{i} )}{{\sum }_{j} exp ( {a}_{j} )} ,$$

and an input

$${\sum }_{i = 1}^{3} {s}_{i} \cdot {e}_{i} ( x )$$

of the task A may be obtained according to the weights calculated by the gate A. A processing process of a task B is similar to the processing process of the task A and a function of a gate B is similar to that of the gate A.

Although multi-task learning may be performed by using a multi-gate mixture-of-experts method, there are several problems, which are respectively (1) all experts in a multi-gate mixture-of-experts (MMOE) model are shared by all tasks, but this is not necessarily an optimal manner; (2) a combination of experts in the MMOE model is linear (a weighted sum), and a representation capability is limited; and (3) when a quantity of expert layers increases, it is difficult to determine input selection of a gate.

To resolve the above problems, the embodiments of this application provide a method and an apparatus for constructing a multi-task learning model, an electronic device, and a computer-readable storage medium, which can automatically and accurately construct a multi-task learning model, to improve the efficiency of constructing the multi-task learning model.

The following describes an exemplary application of the electronic device for constructing a multi-task learning model provided by the embodiments of this application.

The electronic device for constructing a multi-task learning model provided by the embodiments of this application may be various types of terminal devices or servers. The server may be an independent physical server, or may be a server cluster or a distributed system including a plurality of physical servers, or may be a cloud server that provides cloud computing services. The terminal may be a smart phone, a tablet computer, a notebook computer, a desktop computer, a smart speaker, a smart watch, or the like, which is not limited thereto. The terminal and the server may be directly or indirectly connected in a wired or wireless communication manner. This is not limited in this application.

The server may be, for example, a server cluster deployed on cloud and opens an AI as a service (AIaaS) to a developer. An AIaaS platform splits several types of common AI services and provides an independent or package service in the cloud. This service mode is similar to an AI theme mall, and all developers can access to one or more AI services provided by the AIaaS platform by using an application programming interface. For example, one AIaaS is a multi-task learning model construction service, that is, a multi-task learning model construction program is encapsulated in a cloud server. The developer invokes the multi-task learning model construction service in the cloud service by using a terminal, so that the server deployed on the cloud invokes the encapsulated multi-task learning model construction program, determines a multi-task learning model from a constructed search space, and subsequently performs recommendation application according to the multi-task learning model. For example, for news recommendation application, a click-through rate and a degree of completion of news are predicted by using the multi-task learning model, so that personalized news recommendation is performed according to the click-through rate and the degree of completion of the news.

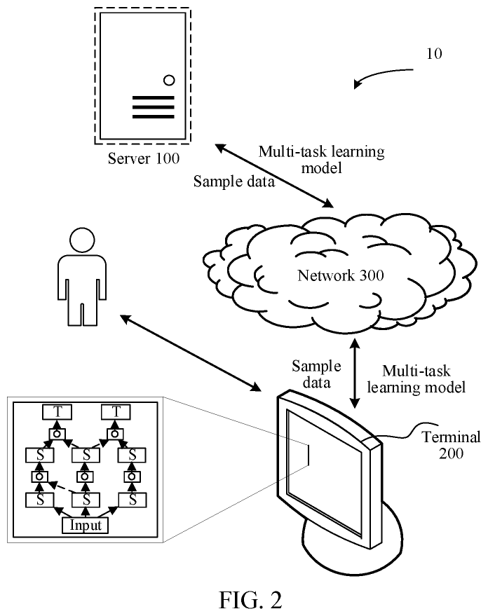

FIG. 2 is a schematic diagram of an application scenario of a system 10 for constructing a multi-task learning model according to an embodiment of this application. A terminal 200 is connected to a server 100 by a network 300. The network 300 may be a wide area network or a local area network or a combination of a wide area network and a local area network.

The terminal 200 (on which a client such as a news client or a video client runs) may be configured to obtain sample data. For example, a developer inputs a recommendation sample data set by using a terminal, and after the input is completed, the terminal automatically obtains the recommendation sample data set.

In some embodiments, a plug-in for constructing a multi-task learning model may be implanted in the client running in the terminal 200, to locally perform the method for constructing a multi-task learning model provided by the embodiments of this application, so as to determine a multi-task learning model from a constructed search space. For example, a recommendation client such as a video client or a news client is installed on the terminal 200, and after the developer inputs a recommendation sample data set in the recommendation client, the terminal 200 invokes the plug-in for construction a multi-task learning model to construct a search space formed by a plurality of subnetwork layers and a plurality of search layers, searches the search space for a multi-task learning model for performing multi-task prediction according to sample data, and subsequently performs recommendation application according to the multi-task learning model. For example, for video application, click-through rates and degrees of completion of videos are predicted by using the multi-task learning model, so that a recommended video is determined according to the click-through rates and the degrees of completion of the videos and personalized video recommendation is performed by using the video client. For news application, exposure rates and click-through rates of news are predicted by using the multi-task learning model, so that recommended news is determined according to the exposure rates and the click-through rates of the news and personalized news recommendation is performed by using the news client.

In some embodiments, the terminal 200 may also send, by using the network 300, the recommendation sample data set inputted by the developer in the terminal 200 to the cloud server 100 and invoke a multi-task learning model construction interface (which may be provided in the form of cloud service such as a multi-task learning model construction service, that is, a multi-task learning model construction program is encapsulated) of the server 100. After receiving the recommendation sample data set, the server 100 determines a multi-task learning model from a constructed search space by using the method for constructing a multi-task learning model provided by the embodiments of this application. For example, a recommendation client (for example, a shopping client) is installed on the terminal 200, the developer inputs a recommendation sample data set in the recommendation client, and the terminal 200 invokes the multi-task learning model construction program of the server 100 by using the network 300, that is, invokes the encapsulated multi-task learning model construction program to construct a search space formed by a plurality of subnetwork layers and a plurality of search layers, searches the search space for a multi-task learning model for performing multi-task prediction according to sample data, and subsequently performs recommendation application according to the multi-task learning model. For example, for shopping application, the server predicts click-through rates and purchase rates of commodities by using the multi-task learning model, determines a recommended commodity according to the click-through rates and the purchase rates of the commodities, returns the recommended commodity to the shopping client, and performs personalized commodity recommendation by using the shopping client.

The following describes a structure of the electronic device for constructing a multi-task learning model provided by the embodiments of this application. The electronic device for constructing a multi-task learning model may be various terminals such as a mobile phone or a computer or may be the server 100 shown in FIG. 2.

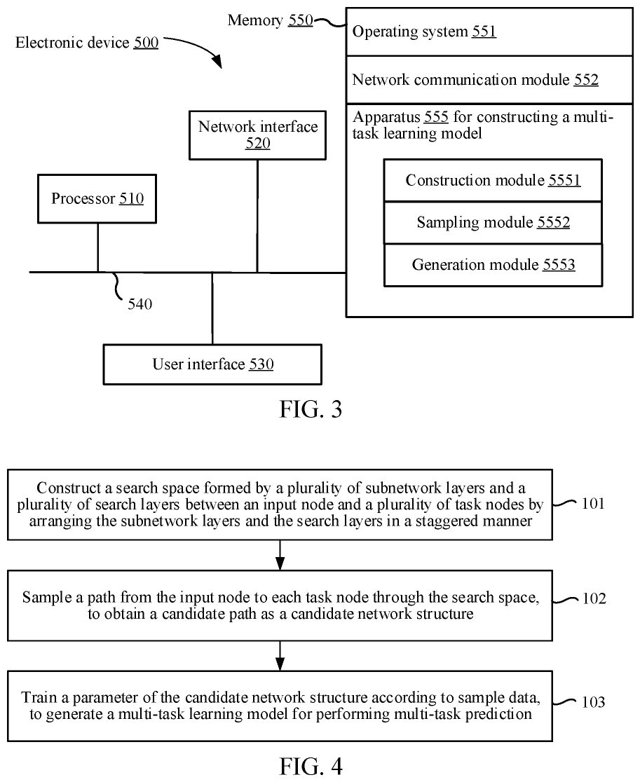

FIG. 3 is a schematic structural diagram of an electronic device 500 for constructing a multi-task learning model according to an embodiment of this application. A description is made by using an example in which the electronic device 500 is a server. The electronic device 500 for constructing a multi-task learning model shown in FIG. 3 includes: at least one processor 510, a memory 550, at least one network interface 520, and a user interface 530. All the components in the electronic device 500 are coupled together by using a bus system 540. It may be understood that, the bus system 540 is configured to implement connection and communication between the components. In addition to a data bus, the bus system 540 further includes a power bus, a control bus, and a status signal bus. However, for ease of clear description, all types of buses are marked as the bus system 540 in FIG. 3.

The processor 510 may be an integrated circuit chip having a signal processing capability, for example, a general-purpose processor, a digital signal processor (DSP), or another programmable logic device (PLD), discrete gate, transistor logical device, or discrete hardware component. The general-purpose processor may be a microprocessor, any conventional processor, or the like.

The memory 550 includes a volatile memory or a non-volatile memory, or may include a volatile memory and a non-volatile memory. The non-volatile computer may be a read-only memory (ROM), and the volatile memory may be a random access memory (RAM). The memory 550 described in this embodiment of this application is to include any other suitable type of memories. The memory 550 optionally includes one or more storage devices that are physically away from the processor 510.

In some embodiments, the memory 550 may store data to support operations of Various. Examples of the data include programs, modules, and data structures, or a subset or a superset thereof, which are illustrated below.

An operating system 551 includes a system program configured to process various basic system services and perform a hardware-related task, for example, a framework layer, a core library layer, and a driver layer, and is configured to implement various basic services and process a hardware-related task.

A network communication module 552 is configured to reach another computing device through one or more (wired or wireless) network interfaces 520. Exemplary network interfaces 520 include: Bluetooth, wireless compatible authentication (WiFi), a universal serial bus (USB), and the like.

In some embodiments, the apparatus for constructing a multi-task learning model provided by the embodiments of this application may be implemented by using software such as the plug-in for constructing a multi-task learning model in the terminal described above or the multi-task learning model construction service in the server described above.

Certainly, this is not limited thereto. The apparatus for constructing a multi-task learning model provided by the embodiments of this application may be provided as various software embodiments, including various forms including application programs, software, software modules, scripts, or computer codes.

In conclusion, the method for constructing a multi-task learning model provided by the embodiments of this application may be implemented as a computer program product in any form, and deployed into various electronic devices as required.

FIG. 3 shows an apparatus 555 for constructing a multi-task learning model stored in the memory 550. The apparatus may be software in the form of a program, a plug-in, or the like and includes a series of modules such as a construction module 5551, a sampling module 5552, and a generation module 5553. The construction module 5551, the sampling module 5552, and the generation module 5553 are configured to implement functions of constructing a multi-task learning model provided by the embodiments of this application.

It may be understood from the above that the method for constructing a multi-task learning model provided by the embodiments of this application may be implemented by various types of electronic devices for constructing a multi-task learning model, for example, an intelligent terminal and a server.

The method for constructing a multi-task learning model provided by the embodiments of this application is described below with reference to an exemplary application and implementation of the server provided by the embodiments of the application. FIG. 4 is a schematic flowchart of a method for constructing a multi-task learning model according to an embodiment of this application, and steps shown in FIG. 4 are combined for description.

In the following steps, involved input node and task node respectively correspond to an entry and an exit of a multi-task learning model. Data received by the input node is used as the basis for a plurality of task nodes (that is, at least two task nodes) to perform a classification or prediction task. A quantity of task nodes is related to a quantity of classification or prediction tasks that need to be implemented in a specific application scenario.

Step 101. Construct a search space formed by a plurality of subnetwork layers and a plurality of search layers between an input node and a plurality of task nodes by arranging the subnetwork layers and the search layers in a staggered manner.

As an example of obtaining sample data, a developer may input a sample data set in a terminal. After the input is completed, the terminal automatically sends the sample data set to a server, and the server receives the sample data set. For a recommendation application scenario, the sample data is recommendation sample data. For example, for news recommendation application, the sample data is news sample data. For commodity recommendation application, the sample data is commodity sample data. For movie recommendation application, the sample data is movie sample data.

After receiving the sample data set, the server invokes a multi-task learning model construction program to construct a search space formed by a plurality of subnetwork layers and a plurality of search layers between an input node and a plurality of task nodes. The subnetwork layers and the search layers are arranged in a staggered manner. Each subnetwork layer includes a plurality of subnetwork modules and each search layer includes a plurality of search blocks. For example, the input node is connected to a first subnetwork layer, the first subnetwork layer is connected to a first search layer, the first search layer is connected to a second subnetwork layer, and so on, until the last search layer is connected to a task node, that is, the search space formed by the plurality of subnetwork layers and the plurality of search layers is constructed between the input node and the plurality of task nodes. After the search space is determined, a multi-task learning model is obtained from the search space, and multi-task prediction is performed by using the multi-task learning model.

For a recommendation application scenario, a search space formed by a plurality of subnetwork layers and a plurality of search layers is constructed between an input node and a plurality of task node for recommendation prediction by arranging the subnetwork layers and the search layers in a staggered manner. An input of the input node is recommendation data, for example, commodity data or news data. An output of the task node is a predicted result for the recommendation data, for example, a click-through rate and a degree of completion (for example, a degree of completion of video viewing and a browsing time of news).

When a successor node in the search layer is a subnetwork module in the subnetwork layer, an output of a search block in the search layer is an input of the subnetwork module. When the successor node in the search layer is a task node, the output of the search block in the search layer is an input of the task node.

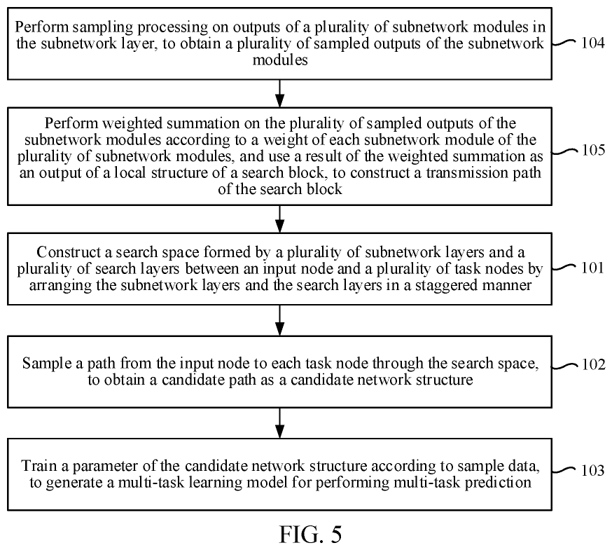

FIG. 5 is an optional schematic flowchart of a method for constructing a multi-task learning model according to an embodiment of this application and FIG. 5 shows that FIG. 4 further includes step 104 and step 105. Step 104. Perform sampling processing on outputs of a plurality of subnetwork modules in the subnetwork layer, to obtain a plurality of sampled outputs of the subnetwork modules. Step 105. Perform weighted summation on the plurality of sampled outputs of the subnetwork modules according to a weight of each subnetwork module of the plurality of subnetwork modules, and use a result of the weighted summation as an output of a local structure of a search block, to construct a transmission path of the search block, the search block being a module in a search layer adjacent to the subnetwork layer.

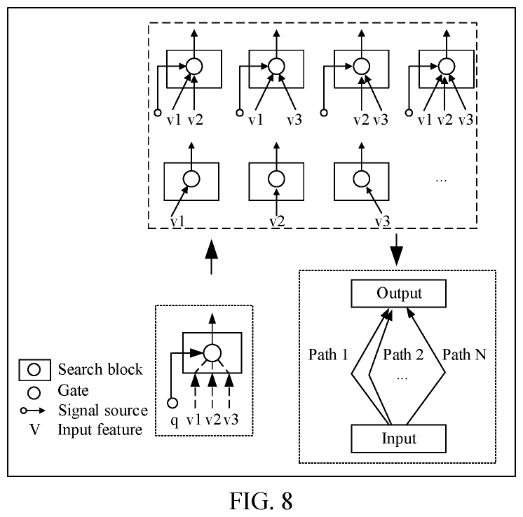

As an example, before the search space is constructed, a structure of a search block in each search layer is constructed. Sampling processing is performed on outputs of a plurality of subnetwork modules in a subnetwork layer, to obtain a plurality of sampled outputs of the subnetwork modules. As shown in FIG. 8, there are three subnetwork modules in a subnetwork layer, and outputs (v1, v2, v3) of the three subnetwork modules may be sampled, to obtain seven sampling results, that is, (v1), (v2), (v3), (v1 and v2), (v1 and v3), (v2 and v3), and (v1, v2, and v3). When an output of one subnetwork module is obtained through sampling, for example, (v1), (v2), or (v3), the output of the subnetwork module is used as an output of a local structure of a search block, to construct a transmission path of the search block. The search block is a module in a search layer adjacent to the subnetwork layer. When outputs of a plurality of subnetwork modules are obtained through sampling, for example, (v1 and v2), (v1 and v3), (v2 and v3), or (v1, v2, and v3), weighted summation is performed on the outputs of the plurality of subnetwork modules according to a weight of each subnetwork module of the plurality of subnetwork modules, and a result of the weighted summation is used as an output of a local structure of a search block, to construct a transmission path of the search block. The search block is a module in a search layer adjacent to the subnetwork layer. Therefore, by constructing a plurality of transmission paths of the search block, the subsequently constructed search space can include sufficient possible network structures, so that a specific multi-task learning problem can be resolved.

In some embodiments, the search block further includes a gated node. After the performing sampling processing on outputs of a plurality of subnetwork modules in the subnetwork layer, the method further includes: sampling a signal source from a signal source set of the subnetwork layer, the signal source being an output of the input node or an output of a predecessor subnetwork module in the subnetwork layer; predicting the signal source by using the gated node, to obtain a predicted value of each subnetwork module of the plurality of subnetwork modules; and performing normalization processing on the predicted value of each subnetwork module, to obtain the weight of each subnetwork module.

According to the above example, to construct the plurality of transmission paths of the search block, for a subnetwork layer, the server may sample a signal source from a signal source set of the subnetwork layer and predict the signal source by using a gated node, to obtain a predicted value, that is, e=w^{k}\hat{q}, where e=[e₁, e₂, . . . , eₛ], of each subnetwork module of a plurality of subnetwork modules in the subnetwork layer. e represents predicted values of the plurality of subnetwork modules in the subnetwork layer, \hat{q} represents the signal source, and w^{k} represents a learnable parameter of a gate. After obtaining the predicted value of each subnetwork module, the server may perform normalization on the predicted value of each subnetwork module, to obtain a weight of each subnetwork module, that is,

$${m}_{i} = \frac{exp ( {e}_{i} )}{{\sum }_{j = 1}^{s} exp ( {e}_{j} )} ,$$

s representing a quantity of subnetwork modules. Therefore, different weights are determined by using different signal sources, so that a plurality of transmission paths of a search block are constructed, and a subsequently constructed search space can include sufficient possible network structures, thereby resolving a specific multi-task learning problem.

In some embodiments, the search space includes N subnetwork layers and N search layers, N being a natural number greater than 1; and before the constructing a search space formed by a plurality of subnetwork layers and a plurality of search layers, the method further includes: sampling outputs of a plurality of subnetwork modules from a first subnetwork layer by using an i^{th} search block in a first search layer, i being a positive integer, performing weighted summation on the outputs of the plurality of subnetwork modules according to a weight of each subnetwork module of the plurality of subnetwork modules when the signal source is the output of the input node, and using a result of the weighted summation as an output of a local structure of the i^{th} search block, to construct a transmission path of the i^{th} search block, until transmission paths of all local structures of the i^{th} search block are constructed; and sampling outputs of a plurality of subnetwork modules from a j^{th} subnetwork layer by using an i^{th} search block in a j^{th} search layer, 1<j≤N, and j being a natural number, performing weighted summation on the outputs of the plurality of subnetwork modules according to a weight of each subnetwork module of the plurality of subnetwork modules when the signal source is the output of the input node or an output of a predecessor subnetwork module in the j^{th} subnetwork layer, and using a result of the weighted summation as an output of a local structure of the i^{th} search block in the j^{th} search layer, to construct a transmission path of the i^{th} search block in the j^{th} search layer, until transmission paths of all local structures of the i^{th} search block in the j^{th} search layer are constructed.

As an example, an output of one subnetwork module or outputs of a plurality of subnetwork modules is/are sampled from a first subnetwork layer by using an i^{th} search block in a first search layer, when a signal source of the first search layer is an output of the input node, the signal source is predicted by using a gated node, to obtain a predicted value of each subnetwork module of the plurality of subnetwork modules, normalization processing is performed on the predicted value of each subnetwork module, to obtain a weight of each subnetwork module, weighted summation is performed on the outputs of the plurality of subnetwork modules according to the weight of each subnetwork module of the plurality of subnetwork modules, and a result of the weighted summation is used as an output of a local structure of the i^{th} search block, to construct a transmission path of the i^{th} search block, until transmission paths of all local structures of the i^{th} search block are constructed.

Outputs of a plurality of subnetwork modules are sampled from a j^{th} subnetwork layer by using an i^{th} search block in a j^{th} search layer, when the signal source of the first search layer is the output of the input node or an output of a predecessor subnetwork module in the j^{th} subnetwork layer, the signal source is predicted by using the gated node, to obtain a predicted value of each subnetwork module of the plurality of subnetwork modules, normalization processing is performed on the predicted value of each subnetwork module, to obtain a weight of each subnetwork module, weighted summation is performed on the outputs of the plurality of subnetwork modules according to the weight of each subnetwork module of the plurality of subnetwork modules, and a result of the weighted summation is used as an output of a local structure of the i^{th} search block in the j^{th} search layer, to construct a transmission path of the i^{th} search block in the j^{th} search layer, until transmission paths of all local structures of the i^{th} search block in the j^{th} search layer are constructed, so that local structures of all search blocks are constructed.

In some embodiments, the constructing a search space formed by a plurality of subnetwork layers and a plurality of search layers includes: using a transmission path from the input node to a first subnetwork layer, transmission paths from intermediate subnetwork layers to adjacent search layers, and transmission paths from a last search layer to the task nodes as edges of a directed graph; using subnetwork modules in the plurality of subnetwork layers and search blocks in the plurality of search layers as nodes of the directed graph; and combining the nodes and edges of the directed graph, to construct the search space for multi-task learning.

As an example, the search space may be constructed by using a directed graph. A transmission path from the input node to a first subnetwork layer is used as an edge of the directed graph, transmission paths from intermediate subnetwork layers (from the first subnetwork layer to a last subnetwork layer) to adjacent search layers may be further used as edges of the directed graph, for example, a transmission path from a second subnetwork layer to an adjacent second search layer, subnetwork modules in a plurality of subnetwork layers and search blocks in a plurality of search layers are used as nodes of the directed graph, and the search space for multi-task learning is constructed according to the nodes and the edges of the directed graph. Subsequently, the edges of the directed graph may be sampled, to sample the search space, so as to obtain a candidate network structure.

Step 102. Sample a path from the input node to each task node through the search space, to obtain a candidate path as a candidate network structure.

After constructing the search space, the server may sample paths from the input node to each task node through the search space, to determine candidate network structures. Because the search space includes sufficient possible network structures, the path from the input node to each task node through the search space is sample, and the obtained candidate network structure includes various structures, thereby resolving the specific multi-task learning problem.

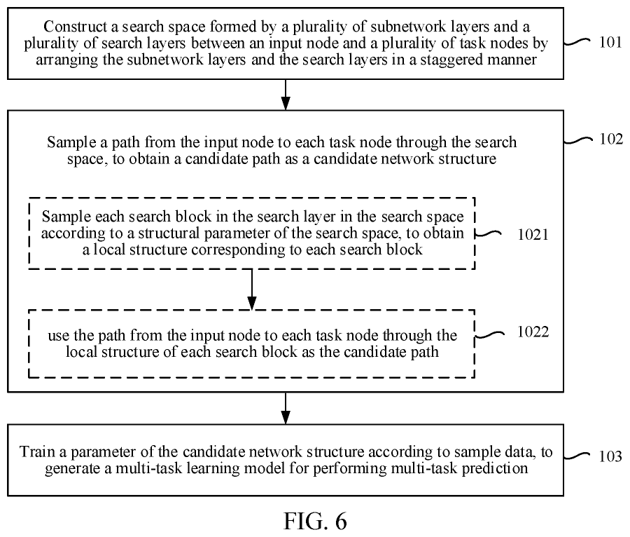

FIG. 6 is an optional schematic flowchart of a method for constructing a multi-task learning model according to an embodiment of this application and FIG. 6 shows that step 102 in FIG. 4 may be implemented by using step 1021 and step 1022 in FIG. 6. Step 1021. Sample each search block in the search layer in the search space according to a structural parameter of the search space, to obtain a local structure corresponding to each search block. Step 1022. Use the path from the input node to each task node through the local structure of each search block as the candidate path.

As an example, each search block in the search space includes a plurality of local structures. Therefore, each search block in the search space may be first sampled according to a structural parameter of the search space, to obtain a local structure (a transmission path) of each search block, and a path from the input node to each task node through the local structure of each search block is used as a candidate path, to form a candidate network structure.

In some embodiments, the sampling each search block in the search layer in the search space according to a structural parameter of the search space, to obtain a local structure corresponding to each search block includes: performing mapping processing on the structural parameter of the search space, to obtain sampling probabilities corresponding to the local structures of each search block in the search space; constructing a polynomial distribution of each search block according to the sampling probabilities of the local structures of each search block; and sampling the polynomial distribution of each search block, to obtain the local structure corresponding to each search block.

According to the above example, to sample the local structure of each search block, the structural parameter of the search space may be first mapped, to obtain sampling probabilities of local structures of each search block, and a polynomial distribution of each search block is constructed according to the sampling probabilities of the local structures of each search block, and finally the local structures of each search block are sampled according to the polynomial distribution of each search block, to obtain a local structure corresponding to each search block. For example, when a search space includes B search blocks, a plurality of local structures of each search block are sampled, to obtain a corresponding local structure, so as to obtain B local structures, and the B local structures, the input node, the subnetwork modules, and the task nodes are combined, to obtain a complete candidate network structure.

Step 103. Train a parameter of the candidate network structure according to sample data, to generate a multi-task learning model for performing multi-task prediction.

After performing sampling to obtain the candidate network structure according to the search space, the server trains a parameter of the candidate network structure, and iteratively performs sampling and training operations, to generate a multi-task learning model for performing multi-task prediction. For a recommendation application scenario, a parameter of the candidate network structure may be trained according to recommendation sample data, to generate a multi-task learning model for multi-recommendation prediction. For example, when an output of a task node is a click-through rate and a degree of completion of news, a parameter of a candidate network structure is trained according to news sample data, to generate a multi-task learning model for performing multi-task prediction. The multi-task learning model is configured to predict the click-through rate and the degree of completion of the news and perform news recommendation according to the click-through rate and the degree of completion of the news.

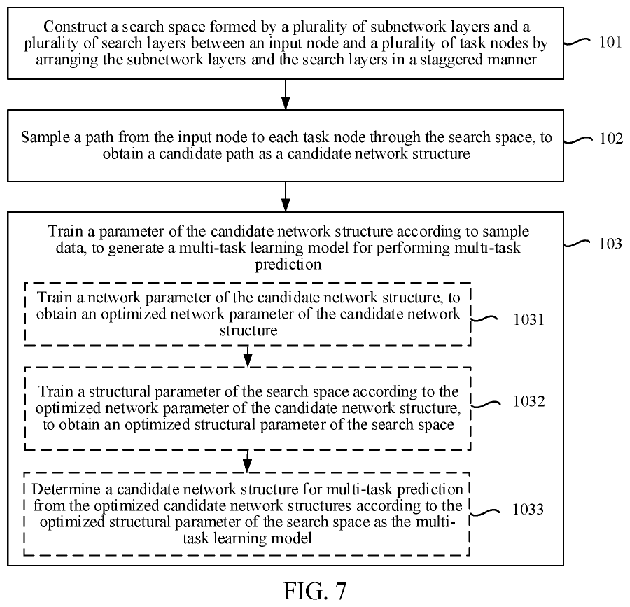

FIG. 7 is an optional schematic flowchart of a method for constructing a multi-task learning model according to an embodiment of this application and FIG. 7 shows that step 103 in FIG. 4 may be implemented by using step 1031 to step 1033 in FIG. 7. Step 1031. Train a network parameter of the candidate network structure, to obtain an optimized network parameter of the candidate network structure. Step 1032. Train a structural parameter of the search space according to the optimized network parameter of the candidate network structure, to obtain an optimized structural parameter of the search space. Step 1033. Determine a candidate network structure for multi-task prediction from the optimized candidate network structures according to the optimized structural parameter of the search space as the multi-task learning model.

As an example, after performing sampling to obtain the candidate network structure, the server may first train a network parameter of the candidate network structure and then train a structural parameter, or may first train a structural parameter and then train a network parameter. For example, a network parameter of the candidate network structure may be trained, to obtain an optimized network parameter of the candidate network structure, and then a structural parameter of the search space is trained according to the optimized candidate network structure (because the candidate network structure is formed by the network parameter, the network parameter of the candidate network structure is optimized, that is, the candidate network structure is optimized), to obtain an optimized structural parameter of the search space, and finally a candidate network structure for multi-task prediction is determined from the optimized candidate network structures according to the optimized structural parameter of the search space as a multi-task learning model. The network parameter is a parameter of each module (for example, the subnetwork module, the search block, or the task node) in the network structure when performing calculation. The structural parameter is used for representing possibilities that local structures of a search block in a search space are sampled. For example, if an i^{th} search block includes N local structures, a structural parameter αᵢ is an N-dimensional vector, and a larger value of the structural parameter αᵢ indicates a larger possibility that a local structure corresponding to the value is sampled.

In some embodiments, the training a network parameter of the candidate network structure, to obtain an optimized network parameter of the candidate network structure includes: performing multi-task prediction processing on the sample data by using the candidate network structure, to obtain a multi-task prediction result of the sample data; constructing a loss function of the candidate network structure according to the multi-task prediction result and a multi-task label of the sample data; and updating the network parameter of the candidate network structure until the loss function converges, and using the updated parameter of the candidate network structure as the optimized network parameter of the candidate network structure when the loss function converges.

After a value of the loss function of the candidate network structure is determined according to the multi-task prediction result and the multi-task label of the sample data, whether the value of the loss function exceeds a preset threshold may be determined. When the value of the loss function exceeds the preset threshold, an error signal of the candidate network structure is determined based on the loss function, the error signal is back-propagated in the candidate network structure, and a model parameter in each layer is updated during the propagation.

The back-propagation is described herein. Training sample data is inputted into an input layer of a neural network model, passes through a hidden layer, and finally, and reaches an output layer, and a result is outputted, which is a forward propagation process of the neural network model. Because there is an error between an output result of the neural network model and an actual result, an error between the output result and an actual value is calculated, and the error is back-propagated from the output layer to the hidden layer until it is propagated to the input layer. In the back-propagation process, the value of the model parameter is adjusted according to the error. The foregoing process is continuously iterated until convergence is achieved. The candidate network structure belongs to a neural network model.

In some embodiments, the training a structural parameter of the search space according to the optimized network parameter of the candidate network structure, to obtain an optimized structural parameter of the search space includes: evaluating a network structure according to the sample data and the optimized network parameter of the candidate network structure, to obtain an evaluation result of the optimized candidate network structure; constructing a target function of the structural parameter of the search space according to the evaluation result; and updating the structural parameter of the search space until the target function converges, and using the updated structural parameter of the search space as the optimized structural parameter of the search space when the target function converges.

As an example, after obtaining an optimized candidate network structure, the server predicts sample data by using the optimized candidate network structure, to obtain a multi-task prediction result, evaluates the optimized candidate network structure according to the multi-task prediction result, to obtain an evaluation result such as accuracy, an area under receiver operating characteristic (ROC) curve (AUC), and a loss of the optimized candidate network structure, constructs a target function, that is, J(α)=E_{u˜p(α)}Rᵥₐₗ(N(u, wᵤ)), of the structural parameter of the search space according to the evaluation result, where p(α) represents a polynomial distribution determined by using the structural parameter p(α) and Rᵥₐₗ represents the evaluation result of the optimized candidate network structure, updates the structural parameter of the search space until the target function converges, and uses the updated structural parameter of the search space as the optimized structural parameter of the search space when the target function converges.

In some embodiments, the determining a candidate network structure for multi-task prediction from the optimized candidate network structures according to the optimized structural parameter of the search space as the multi-task learning model includes: performing mapping processing on the optimized structural parameter of the search space, to obtain sampling probabilities corresponding to local structures of each search block in the search space; using a local structure corresponding to a maximum sampling probability in the local structures of each search block as a local structure of the candidate network structure for multi-task prediction; and combining the local structure of each candidate network structure, to obtain the multi-task learning model.

As an example, after obtaining the optimized structural parameter of the search space, the server may search the search space for an optimal network structure according to the optimized structural parameter of the search space, perform mapping on the optimized structural parameter of the search space, for example, a logistic regression function (a softmax function), to obtain sampling probabilities corresponding to local structures of each search block in the search space, use a local structure corresponding to a maximum sampling probability in the local structures of each search block as a local structure of the candidate network structure for multi-task prediction, and finally combine the local structure of each candidate network structure, to obtain the multi-task learning model.

The following describes an exemplary application of this embodiment of this application in an actual application scenario.

This embodiment of this application is applicable to various recommendation application scenarios. As shown in FIG. 2, the terminal 200 is connected to the server 100 deployed on the cloud by the network 300, and a multi-task learning model construction application is installed on the terminal 200. A developer inputs a recommendation sample data set in the multi-task learning model construction application, the terminal 200 sends the recommendation sample data set to the server 100 by using the network 300, and after receiving the recommendation sample data set, the server 100 determines an optimal network structure from a constructed search space as a multi-task learning model, and subsequently performs recommendation application according to the multi-task learning model. For example, for news recommendation application, a click-through rate and a degree of completion of news are predicted by using the multi-task learning model, so that personalized news recommendation is performed according to the click-through rate and the degree of completion of the news. For commodity recommendation application, a click-through rate (CTR) and a conversion rate (CVR) of a commodity are predicted by using the multi-task learning model, so that personalized commodity recommendation is performed according to the CTR and the CVR of the commodity. For movie recommendation application, a purchase rate and a score of a user of a movie are predicted by using the multi-task learning model, so that personalized movie recommendation is performed according to the purchase rate and the score of the user of the movie.

Although in the related art, multi-task learning may be performed by using a multi-gate mixture-of-experts method, there are several problems, which are respectively (1) all experts in a multi-gate mixture-of-experts (MMOE) model are shared by all tasks, but this is not necessarily an optimal manner; (2) a combination of experts in the MMOE model is linear (a weighted sum), and a representation capability is limited; and (3) when a quantity of expert layers increases, it is difficult to determine input selection of a gate.

To resolve the above problems, in this embodiment of this application, from the perspective of neural network architecture search, an optimal network structure is found from a search space by using a search algorithm to greatly reduce the costs of manually adjusting a network structure. First, a search space is designed. The space enumerates correspondences between subnetwork modules (experts) and between subnetwork modules and tasks. Because the search space may include a plurality of layers, and an input source of a gate is also included in the search space, that is, the search space includes the MMOE model. In this embodiment of this application, an optimal network structure is efficiently found from the search space by using polynomial distribution sampling and a policy gradient algorithm in a differentiable manner as a multi-task learning model, to achieve a better effect than the multi-gate mixture-of-experts method.

A method for constructing a multi-task learning model provided in this embodiment of this application is described below. The method includes two parts, which are respectively: (1) construction of a search space; and (2) search algorithm.

(1) Construction of a Search Space

An objective of constructing a search space is to cause the search space to include sufficient possible network structures to resolve a specific multi-task learning problem. First, a parameter sharing part is divided into a plurality of subnetworks. It is assumed that for a machine learning problem with T tasks, there are L subnetwork layers (experts), and each layer has H subnetwork modules.

Generally, the search space is formed by a plurality of search blocks. Each search block represents a sub-search space and includes a plurality of local network structures (for example, connections between the subnetwork modules). The following describes a specific structure of a search block.

As shown in FIG. 8, a search block represents a sub-search space and includes a plurality of different local network structures (local structures). For a local structure, input features are dynamically aggregated by using a gate. The local structure is affected by two factors, which are respectively: (1) different inputs (a combination); and (2) different gate signal sources (signal sources).

A sub-search space represented by a search block may be formally represented as R=V×Q, R V, and Q all representing sets, × representing a Cartesian product, V represents a combination of all input features (inputs are from outputs of subnetwork modules in a previous layer), the set V representing |V|=C₁^{H}+C₂^{H}+ . . . +C_{H}^{H}=2^{H}−1, Q representing all possible gate signal sources, for example, inputs of all previous subnetwork layers and an originally shared input may be used as signal sources, and R representing the sub-search space. That is, there may be a total of |R| different local structures in a search block. For any local structure (a k^{th} local structure, 0<k≤|R|) in the search block, an input of the k^{th} local structure is \hat{V}∈R^{s*d}^{ᵥ} (s input features, and each feature is a dᵥ-dimension) and \hat{q}∈R^{d}^{_{q}} (a gate signal source, and a dimension is d_{q}, and an output of the k^{th} local structure is that is, a weighted sum of the input features, so that a calculation formula is shown in formula (1):

$${y}_{k} = {g}^{k} ( \hat{q} , \hat{V} ) = {\sum }_{i = 1}^{s} {m}_{i} {v}_{i} where {m}_{i} = \frac{exp ( {e}_{i} )}{{\sum }_{j = 1}^{s} exp ( {e}_{j} )} , e = {w}^{k} \hat{q} , e = [ {e}_{1} , {e}_{2} , … , {e}_{s} ] , \qquad ( 1 )$$

g^{k} represents gates of the local structure, mᵢ represents a gate score (a predicted value) of an i^{th} input feature, and w^{k} represents a learnable parameter of the gate.

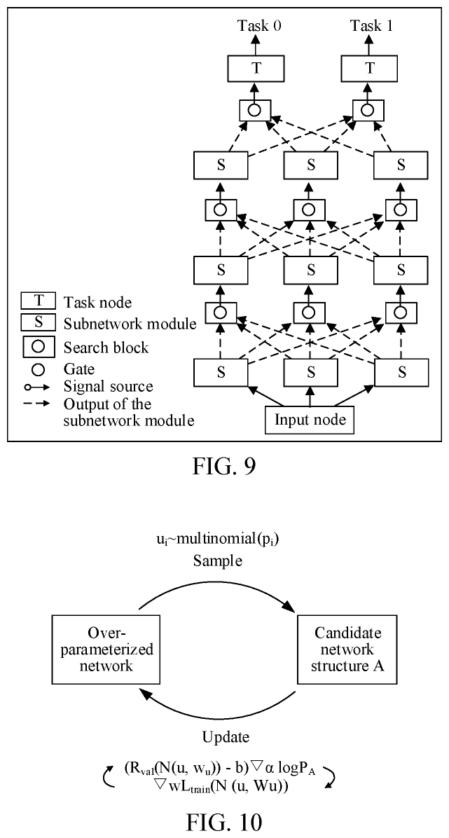

As shown in FIG. 9, search blocks in a search space are located between two adjacent subnetwork layers or located between a last subnetwork layer and a task layer (including a plurality of task nodes. Therefore, a total quantity of search block is B=(L−1)*H+T, T representing a quantity of task nodes. In this embodiment of this application, a search space A may be represented as a Cartesian product A=Πᵢ₌^{B}Rᵢ of a space represented by B search blocks, that is, may be considered as an over-parameterized network formed physically. The over-parameterized may include complex network structures.

(2) Search Algorithm

An objective of this embodiment of this application is to find a network structure with a best effect from the over-parameterized network. Each search block includes |Rⁱ| local structures, i∈[1, 2, . . . , B]. A local structure is selected from each search block, and all local structures may be combined to determine a complete network structure. The complete network structure is defined as N (u, wᵤ), u∈R^{B} representing B local structure determined by using B sampling actions, wᵤ representing a network parameter of the network structure (the network parameter is a parameter of each module in the network structure when performing calculation, for example, w^{k} in formula 1).

For optimization of a structural parameter, a sampling action uᵢ(i∈[1, 2, . . . , B]) is set to sample from a polynomial distribution determined by a structural parameter αᵢ∈R^{|R}^{ⁱ}^{|} (i∈[1, 2, . . . , B]). The structural parameter αᵢ is used for representing possibilities that local structures of an i^{th} search block in a search space are sampled. For example, if an i^{th} search block includes N local structures, the structural parameter αᵢ is an N-dimensional vector, and a larger value of the structural parameter αᵢ indicates a larger possibility that a local structure corresponding to the value is sampled, and a calculation formula is shown in formula (2) and formula (3):

uᵢ˜multinomial(p₁) (2)

pᵢ=softmax(αᵢ) (3)

where multinomial( ) represents a polynomial distribution, softmax( ) represents a logistic regression function, and pᵢ represents probabilities that local structures of an i^{th} search block are sampled. Therefore, a complete network structure may be obtained by sampling B polynomial distributions. To handle a non-differentiable evaluation index, in this embodiment of this application, the structural parameter is optimized by using a reinforcement learning policy gradient (REINFORCE) algorithm. During optimization of the structural parameter, a network structure with good performance on a specified evaluation index has a higher sampling probability, and a formula of an optimization target of the structural parameter is shown in formula (4):

J(α)=E_{u˜p(α)}Rᵥₐₗ(N(u,wᵤ)) (4)

where p(α) represents a polynomial distribution determined by the structural parameter α, and Rᵥₐₗ represents a score (an evaluation result) of a sampled structure on a specific index (for example, accuracy, an AUC, or a loss). A gradient of the structural parameter is obtained by using the following formula (5) and according to the REINFORCE algorithm:

∇J(α)=(Rᵥₐₗ(N(u,wᵤ))−b)∇_{α}log p_{α} (5)

where b represents a reference used for reducing a return variance, a moving average may be used as the reference, and b may alternatively be 0.

As shown in FIG. 10, during each iteration, a candidate network structure is sampled from an over-parameterized network, and then a structural parameter and a corresponding network parameter are alternately trained. As the iteration progresses, a probability of sampling a network structure with good performance will increase. After the search is completed, a local structure with a maximum probability is selected from each search block, so that all local structures with maximum probabilities are combined to obtain a complete network structure. A search process and obtaining pseudocode of an optimal network structure are shown in the following algorithm 1:

```
  Algorithm 1: a search process and obtaining an optimal network
  structure
  Input: training sample data, verification data, and an over-parameterized
network including B search blocks
  Output: an optimized structural parameter α and network parameter w
    Initialize a structural parameter α and a network parameter w
    while the structural parameter α and the network parameter w do not
converge do
      for the search blocks Rᵢ in the over-parameterized network do
        calculate probabilities that local structures are sampled by using
formula (3)
        sample the local structures uᵢ by using formula (2)
      end for
      obtaining a network structure N (u, wᵤ), where u = {uᵢ}ᵢ₌₁^{B}
      update the network parameter w through gradient descent
∇_{w}Lₜᵣₐᵢₙ(N (u,wᵤ))
      update the structural parameter α through gradient ascent by using
formula (5)
    end while
    return to obtain a final network structure based on the optimized
structural parameter α and network parameter w
```

Therefore, the training sample data, the verification data, and the over-parameterized network including the B search blocks are inputted, the optimized structural parameter α and network parameter w may be obtained, and the final network structure is obtained based on the optimized structural parameter α and network parameter w as a multi-task learning model.

Based on the foregoing, in this embodiment of this application, optimization of a network structure may be efficiently performed on a specified multi-task data set, and independent and sharing relationships between different task branches are automatically balanced, so as to search for a better network structure as a multi-task learning model. Multi-task learning is very important in a recommendation system and may be used for optimization of a network structure in multi-task learning (estimation of a plurality of distribution indexes: for example, objectives such as a click-through rate and a degree of completion are predicted) in a service recommendation scenario, a generalization ability of the multi-task learning model is improved by fully using knowledge contained in different tasks (indexes), so as to quickly and accurately obtain a specific index of the recommender system. Compared with designing a network structure by manual trial and error, in this embodiment of this application, can learn the most suitable network structure may be more efficiently learned for training data of a specific service, to accelerate the iterative upgrade of products.

Hereto, the method for constructing a multi-task learning model provided in this embodiment of this application has been described. The following continues to describe a solution for constructing a multi-task learning model implemented by cooperation of each module in an apparatus 555 for constructing a multi-task learning model provided in this embodiment of this application.

The construction module 5551 is configured to construct a search space formed by a plurality of subnetwork layers and a plurality of search layers between an input node and a plurality of task nodes by arranging the subnetwork layers and the search layers in a staggered manner. The sampling module 5552 is configured to sample a path from the input node to each task node through the search space, to obtain a candidate path as a candidate network structure. The generating module 5553 is configured to train a parameter of the candidate network structure according to sample data, to generate a multi-task learning model for performing multi-task prediction.

In some embodiments, the construction module 5551 is further configured to perform sampling processing on outputs of a plurality of subnetwork modules in the subnetwork layer, to obtain a plurality of sampled outputs of the subnetwork modules; and perform weighted summation on the plurality of sampled outputs of the subnetwork modules according to a weight of each subnetwork module of the plurality of subnetwork modules, and use a result of the weighted summation as an output of a local structure of a search block, to construct a transmission path of the search block, the search block being a module in a search layer adjacent to the subnetwork layer.

In some embodiments, the search block further includes a gated node, and the construction module 5551 is further configured to sample a signal source from a signal source set of the subnetwork layer, the signal source being an output of the input node or an output of a predecessor subnetwork module in the subnetwork layer; predict the signal source by using the gated node, to obtain a predicted value of each subnetwork module of the plurality of subnetwork modules; and perform normalization processing on the predicted value of each subnetwork module, to obtain the weight of each subnetwork module.

In some embodiments, the search space includes N subnetwork layers and N search layers, and N is a natural number greater than 1, and the construction module 5551 is further configured to sample outputs of a plurality of subnetwork modules from a first subnetwork layer by using an i^{th} search block in a first search layer, i being a positive integer, perform weighted summation on the outputs of the plurality of subnetwork modules according to a weight of each subnetwork module of the plurality of subnetwork modules when the signal source is the output of the input node, and use a result of the weighted summation as an output of a local structure of the i^{th} search block, to construct a transmission path of the i^{th} search block, until transmission paths of all local structures of the i^{th} search block in the first search layer are constructed; and sample outputs of a plurality of subnetwork modules from a j^{th} subnetwork layer by using an i^{th} search block in a j^{th} search layer, 1<j≤N, and j being a natural number, perform weighted summation on outputs of the plurality of subnetwork modules according to a weight of each subnetwork module of the plurality of subnetwork modules when the signal source is the output of the input node or an output of a predecessor subnetwork module in the j^{th} subnetwork layer, and use a result of the weighted summation as an output of a local structure of the i^{th} search block in the j^{th} search layer, to construct a transmission path of the i^{th} search block in the j^{th} search layer, until transmission paths of all local structures of the i^{th} search block in the j^{th} search layer are constructed.

In some embodiments, when a successor node in the search layer is a subnetwork module in the subnetwork layer, an output of a search block in the search layer is an input of the subnetwork module; and when the successor node in the search layer is the task node, the output of the search block in the search layer is an input of the task node.

In some embodiments, the construction module 5551 is further configured to use a transmission path from the input node to first subnetwork layer, transmission paths from intermediate subnetwork layers to adjacent search layers, and transmission paths from a last search layer to the task nodes as edges of a directed graph; use subnetwork modules in the plurality of subnetwork layers and search blocks in the plurality of search layers as nodes of the directed graph; and combine the nodes and the edges of the directed graph, to obtain the search space for multi-task learning.

In some embodiments, the sampling module 5552 is further configured to sample each search block in the search layer in the search space according to a structural parameter of the search space, to obtain a local structure corresponding to each search block; and use the path from the input node to each task node through the local structure of each search block as the candidate path.

In some embodiments, the sampling module 5552 is further configured to perform mapping processing on the structural parameter of the search space, to obtain sampling probabilities corresponding to the local structures of each search block in the search space; construct a polynomial distribution of each search block according to the sampling probabilities of the local structures of each search block; and sample the polynomial distribution of each search block, to obtain the local structure corresponding to each search block.

In some embodiments, the generation module 5553 is further configured to train a structural parameter of the search space according to the optimized network parameter of the candidate network structure, to obtain an optimized structural parameter of the search space; and determine a candidate network structure for multi-task prediction from the optimized candidate network structures according to the optimized structural parameter of the search space as the multi-task learning model.

In some embodiments, the generation module 5553 is further configured to perform multi-task prediction processing on the sample data by using the candidate network structure, to obtain a multi-task prediction result of the sample data; construct a loss function of the candidate network structure according to the multi-task prediction result and a multi-task label of the sample data; and update the network parameter of the candidate network structure until the loss function converges, and using the updated parameter of the candidate network structure as the optimized network parameter of the candidate network structure when the loss function converges.

In some embodiments, the generation module 5553 is further configured to evaluate a network structure according to the sample data and the optimized network parameter of the candidate network structure, to obtain an evaluation result of the optimized candidate network structure; construct a target function of the structural parameter of the search space according to the evaluation result; and update the structural parameter of the search space until the target function converges, and using the updated structural parameter of the search space as the optimized structural parameter of the search space when the target function converges.

In some embodiments, the sampling module 5553 is further configured to perform mapping processing on the optimized structural parameter of the search space, to obtain sampling probabilities corresponding to the local structures of each search block in the search space; use a local structure corresponding to a maximum sampling probability in the local structures of each search block as a local structure of the candidate network structure for multi-task prediction; and combine the local structure of each candidate network structure, to obtain the multi-task learning model.

The foregoing descriptions are merely embodiments of this application and are not intended to limit the protection scope of this application. Any modification, equivalent replacement, or improvement made without departing from the spirit and range of this application shall fall within the protection scope of this application.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

As used herein, the term “unit” or “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit. The division of the foregoing functional modules is merely used as an example for description when the systems, devices, and apparatus provided in the foregoing embodiments performs a method for constructing a multi-task learning model. In practical application, the foregoing functions may be allocated to and completed by different functional modules according to requirements, that is, an inner structure of a device is divided into different functional modules to implement all or a part of the functions described above.

What is claimed is:

1. A method for constructing a multi-task learning model, comprising:
constructing a search space between an input node and a plurality of task nodes by arranging a plurality of subnetwork layers and a plurality of search layers in a staggered manner, wherein a search layer in the plurality of search layers is arranged between two subnetwork layers of the plurality of subnetwork layers;
sampling a path from the input node to each task node of the plurality of task nodes through the search space to obtain a candidate path as a candidate network structure; and
training a parameter of the candidate network structure according to sample data to generate the multi-task learning model for performing a multi-task prediction.

2. The method according to claim 1, further comprising:
prior to constructing the search space, for a respective subnetwork layer of the plurality of subnetwork layers:
performing sampling processing on outputs of a plurality of subnetwork modules in the respective subnetwork layer to obtain a plurality of sampled outputs of the plurality of subnetwork modules;
performing weighted summation on the plurality of sampled outputs of the plurality of subnetwork modules according to a weight of each subnetwork module of the plurality of subnetwork modules; and
constructing a transmission path of a search block using a result of the weighted summation as an output of a local structure of the search block, wherein the search block is a module in a search layer adjacent to the subnetwork layer.

3. The method according to claim 2, wherein
the search block further comprises a gated node, and
the method further comprises:
after performing sampling processing on the outputs of the plurality of subnetwork modules in the respective subnetwork layer:
sampling a signal source from a signal source set of the subnetwork layer, the signal source being an output of the input node or an output of a predecessor subnetwork module in the subnetwork layer;
predicting the signal source by using the gated node, to obtain a predicted value of each subnetwork module of the plurality of subnetwork modules; and
performing normalization processing on the predicted value of each subnetwork module to obtain the weight of each subnetwork module.

4. The method according to claim 3, wherein
the search space comprises N subnetwork layers and N search layers, and N is a natural number greater than 1, and
the method further comprises:
prior to constructing the search space:
sampling outputs of a plurality of subnetwork modules from a first subnetwork layer using an i^{th} search block in a first search layer, wherein i is a positive integer;
performing weighted summation on the outputs of the plurality of subnetwork modules according to a weight of each subnetwork module of the plurality of subnetwork modules when the signal source is the output of the input node, and using a result of the weighted summation as an output of a local structure of the i^{th} search block, to construct a transmission path of the i^{th} search block, until transmission paths of all local structures of the i^{th} search block in the first search layer are constructed;
sampling outputs of a plurality of subnetwork modules from a j^{th} subnetwork layer by using an i^{th} search block in a j^{th} search layer, 1<j≤N, and j being a positive integer; and
performing weighted summation on the outputs of the plurality of subnetwork modules according to a weight of each subnetwork module of the plurality of subnetwork modules when an output of a predecessor subnetwork module in the j^{th} subnetwork layer, and using a result of the weighted summation as an output of a local structure of the i^{th} search block in the j^{th} search layer, to construct a transmission path of the i^{th} search block in the j^{th} search layer, until transmission paths of all local structures of the i^{th} search block in the j^{th} search layer are constructed.

5. The method according to claim 1, wherein
when a successor node in the search layer is a subnetwork module in a subsequent subnetwork layer, an output of a search block in the search layer is an input of the subnetwork module; and
when the successor node in the search layer is the task node, the output of the search block in the search layer is an input of the task node.

6. The method according to claim 1, wherein constructing the search space comprises:
combining nodes and the edges of a directed graph to obtain the search space for multi-task learning, wherein subnetwork modules in the plurality of subnetwork layers and search blocks in the plurality of search layers are nodes of the directed graph, and wherein transmission paths from (i) the input node to a first subnetwork layer, (ii) intermediate subnetwork layers to adjacent search layers, and (iii) a last search layer to the task nodes are edges of the directed graph.

7. The method according to claim 1, wherein sampling the path from the input node to each task node of the plurality of task nodes through the search space to obtain the candidate path comprises:
sampling each search block in a respective search layer of the plurality of search layers in the search space according to a structural parameter of the search space to obtain a local structure corresponding to each search block; and
setting the path from the input node to each task node through the local structure of each search block as the candidate path.

8. The method according to claim 7, wherein sampling each search block in the respective search layer of the plurality of search layers in the search space according to the structural parameter of the search space to obtain a local structure corresponding to each search block comprises:
performing mapping processing on the structural parameter of the search space to obtain sampling probabilities corresponding to local structures of each search block in the search space;
constructing a polynomial distribution of each search block according to the sampling probabilities of the local structures of each search block; and
sampling the polynomial distribution of each search block to obtain the local structure corresponding to each search block.

9. The method according to claim 1, wherein training the parameter of the candidate network structure comprises:
training a network parameter of the candidate network structure to obtain an optimized network parameter of the candidate network structure;
training a structural parameter of the search space according to the optimized network parameter of the candidate network structure to obtain an optimized structural parameter of the search space; and
determining a candidate network structure for the multi-task prediction from optimized candidate network structures according to the optimized structural parameter of the search space as the multi-task learning model.

10. The method according to claim 9, wherein training the network parameter of the candidate network structure to obtain the optimized network parameter of the candidate network structure comprises:
performing multi-task prediction processing on the sample data using the candidate network structure to obtain a multi-task prediction result of the sample data;
constructing a loss function of the candidate network structure according to the multi-task prediction result and a multi-task label of the sample data;
updating the network parameter of the candidate network structure until the loss function converges; and setting the updated network parameter of the candidate network structure as the optimized network parameter of the candidate network structure when the loss function converges.

11. The method according to claim 9, wherein training the structural parameter of the search space according to the optimized network parameter of the candidate network structure to obtain the optimized structural parameter of the search space comprises:
evaluating a network structure according to the sample data and the optimized network parameter of the candidate network structure, to obtain an evaluation result of the optimized candidate network structure;
constructing a target function of the structural parameter of the search space according to the evaluation result; and
updating the structural parameter of the search space until the target function converges, and setting the updated structural parameter of the search space as the optimized structural parameter of the search space when the target function converges.

12. The method according to claim 9, wherein determining the candidate network structure for multi-task prediction from the optimized candidate network structures according to the optimized structural parameter of the search space as the multi-task learning model comprises:
performing mapping processing on the optimized structural parameter of the search space to obtain sampling probabilities corresponding to the local structures of each search block in the search space;
selecting a local structure having a maximum sampling probability in the local structures of each search block as a local structure of the candidate network structure for multi-task prediction; and
combining the local structure of each candidate network structure to obtain the multi-task learning model.

13. An electronic device, comprising:
one or more processors; and
memory storing one or more programs, the one or more programs comprising instructions that, when executed by the one or more processors, cause the one or more processors to perform operations comprising:
constructing a search space between an input node and a plurality of task nodes by arranging a plurality of subnetwork layers and a plurality of search layers in a staggered manner, wherein a search layer in the plurality of search layers is arranged between two subnetwork layers of the plurality of subnetwork layers;
sampling a path from the input node to each task node of the plurality of task nodes through the search space to obtain a candidate path as a candidate network structure; and
training a parameter of the candidate network structure according to sample data to generate the multi-task learning model for performing a multi-task prediction.

14. The electronic device according to claim 13, further comprising:
prior to constructing the search space, for a respective subnetwork layer of the plurality of subnetwork layers:
performing sampling processing on outputs of a plurality of subnetwork modules in the respective subnetwork layer to obtain a plurality of sampled outputs of the plurality of subnetwork modules;
performing weighted summation on the plurality of sampled outputs of the plurality of subnetwork modules according to a weight of each subnetwork module of the plurality of subnetwork modules; and
constructing a transmission path of a search block using a result of the weighted summation as an output of a local structure of the search block, wherein the search block is a module in a search layer adjacent to the subnetwork layer.

15. The electronic device according to claim 14, wherein
the search block further comprises a gated node, and
the method further comprises:
after performing sampling processing on the outputs of the plurality of subnetwork modules in the respective subnetwork layer:
sampling a signal source from a signal source set of the subnetwork layer, the signal source being an output of the input node or an output of a predecessor subnetwork module in the subnetwork layer;
predicting the signal source by using the gated node, to obtain a predicted value of each subnetwork module of the plurality of subnetwork modules; and
performing normalization processing on the predicted value of each subnetwork module to obtain the weight of each subnetwork module.

16. The electronic device according to claim 13, wherein constructing the search space comprises:
combining nodes and the edges of a directed graph to obtain the search space for multi-task learning, wherein subnetwork modules in the plurality of subnetwork layers and search blocks in the plurality of search layers are nodes of the directed graph, and wherein transmission paths from (i) the input node to a first subnetwork layer, (ii) intermediate subnetwork layers to adjacent search layers, and (iii) a last search layer to the task nodes are edges of the directed graph.

17. The electronic device according to claim 13, wherein sampling the path from the input node to each task node of the plurality of task nodes through the search space to obtain the candidate path comprises:
sampling each search block in a respective search layer of the plurality of search layers in the search space according to a structural parameter of the search space to obtain a local structure corresponding to each search block; and
setting the path from the input node to each task node through the local structure of each search block as the candidate path.

18. A non-transitory computer-readable storage medium, storing a computer program, the computer program, when executed by one or more processors of an electronic device, cause the one or more processors to perform operations comprising:
constructing a search space between an input node and a plurality of task nodes by arranging a plurality of subnetwork layers and a plurality of search layers in a staggered manner, wherein a search layer in the plurality of search layers is arranged between two subnetwork layers of the plurality of subnetwork layers;
sampling a path from the input node to each task node of the plurality of task nodes through the search space to obtain a candidate path as a candidate network structure; and
training a parameter of the candidate network structure according to sample data to generate the multi-task learning model for performing a multi-task prediction.

19. The non-transitory computer-readable storage medium according to claim 18, further comprising:
prior to constructing the search space, for a respective subnetwork layer of the plurality of subnetwork layers:
performing sampling processing on outputs of a plurality of subnetwork modules in the respective subnetwork layer to obtain a plurality of sampled outputs of the plurality of subnetwork modules;
performing weighted summation on the plurality of sampled outputs of the plurality of subnetwork modules according to a weight of each subnetwork module of the plurality of subnetwork modules; and
constructing a transmission path of a search block using a result of the weighted summation as an output of a local structure of the search block, wherein the search block is a module in a search layer adjacent to the subnetwork layer.

20. The non-transitory computer-readable storage medium to claim 19, wherein
the search block further comprises a gated node, and
the method further comprises:
after performing sampling processing on the outputs of the plurality of subnetwork modules in the respective subnetwork layer:
sampling a signal source from a signal source set of the subnetwork layer, the signal source being an output of the input node or an output of a predecessor subnetwork module in the subnetwork layer;
predicting the signal source by using the gated node, to obtain a predicted value of each subnetwork module of the plurality of subnetwork modules; and
performing normalization processing on the predicted value of each subnetwork module to obtain the weight of each subnetwork module.
